(19) United States
(12) Patent Application Publication
(10) Pub. No.: US 2007/0031210 A1
(43) Pub. Date: Feb. 8, 2007

(54) Method of primary shaping of a molded part, and a molded part produced by primary shaping, in particular a nut

(76) Inventor: Michael Schmidt, Fernwald (DE)

Correspondence Address: HARNESS, DICKEY & PIERCE, P.L.C., P.O. BOX 828, BLOOMFIELD HILLS, MI, 48303, US

(21) Appl. No.: 11/488,862

(22) Filed: Jul. 18, 2006

(30) Foreign Application Priority Data
Jul. 20, 2005 (DE) 10 2005 034 507.7

(51) Int. Cl. F16B 37/16

(52) U.S. Cl. 411/437

(57) ABSTRACT

A shaped molded part having an opening and an internal thread in the opening includes a thread portion in at least two different sectors. A first molding core has the threaded portions in first sectors forming the internal thread and unthreaded recesses in second sectors located between the first sectors. Unthreaded wall segments of the opening are formed by second molding cores arranged in the recesses. To unmold the molded part the second molding core is drawn out of the opening in an axial direction. The first molding core is then rotated in the molded part until the threaded portions face the opening threaded wall segments and then is axially drawn from the opening.

### CROSS-REFERENCE TO RELATED APPLICATIONS

This application claims the benefit of German Patent Application No. 10 2005 034 507.7, filed Jul. 20, 2005. The disclosure of the above application is incorporated herein by reference.

### FIELD

The invention relates to a method of primary shaping of a molded part having an opening and an internal thread configured in the opening, comprising at least two portions of a thread arranged in different sectors, the opening and the portions of the internal thread being shaped by means of mold cores. The invention relates also to a molded part produced by such a method, in particular to a nut.

### BACKGROUND

In the primary shaping of small quantities of molded parts of synthetic material, it is known that internal threads may be formed by means of lost cores inserted in the injection tool, which are unmolded together with the molded parts after the shaping process. Outside of the tool, the core must be turned out of the molded part at considerable expense. It is known also that folding cores may be employed to form internal threads. Here the core is divided into segments, the thread being freed by a radially directed motion of the segments after the shaping process. In the production of segmented threads, readily deformable molding cores may be employed with oblique pushers. Both of these solutions have the disadvantage that they require complicated and costly molding cores. In particular for smaller thread diameters, it is known further that ‘turn-out’ cores may be employed. The unmolding of the turn-out cores requires costly tools and a period of time depending on the length of the thread.

DE A1 4,004,550 discloses a molded part provided with internal thread, composed of two basic members, the parting plane passing through the central axis of the internal thread. The cylindrical, open internal threads of the basic members are simple to unmold in this way. To be sure, the composition of the basic members occasions additional problems of strength and cost.

To avoid the aforesaid problems, it is known further that primary shaped nuts of synthetic material may be provided with a smooth, inner bore, having a tapered introductory portion reduced inward. The inside diameter of the bore is here so dimensioned that the screwing of the nut onto a threaded bolt will configure a thread in the bore of the nut. Such type of a nut of synthetic material is known from EP-B1-0,554,094. Such a nut of synthetic material also comprises a stripping zone formed by a plurality of axially parallel tubular cavities in the introductory portion of the smooth bore. These cavities intersect with the wall of the bore of the nut, so that cutting edges are formed which are intended to scrape off the surface of a screwed-in bolt and remove depositions. Neighboring cavities are connected in each instance by connecting cavities accommodating the material stripped off from the threaded bolt. Nuts of synthetic material, with smooth bore, have the disadvantage of being exposed to higher stress and requiring higher torques in assembly. The load capacity in axial direction is less than in the case of synthetic nuts with pre-formed threads.

Further, DE A 2,058,316 discloses a thread cutting hex nut in which, near one face and proceeding from opposed wrench surfaces, two holes are drilled in the nut, intersecting the internal thread of the nut. The holes run parallel to each other and offset from the mid-axis of the nut, thus forming cutting edges for the cutting of threads at the intersections of the holes with the thread. This nut is not suitable for simple production by primary shaping.

A method and a molded part of the kind initially mentioned are disclosed in DE U1 296 18 639. The primary shaped part has a through, substantially circular opening in which two portions of a single uniformly rising thread are configured. The two portions, located opposed to each other, each extend over a peripheral angle of 170°, thus forming an almost complete thread. The internal thread is formed with two mold cores, separated from each other along the thread surface, and forming the two portions as well as the two adjoining segments of the opening. For unmolding, the two mold cores can be quite easily and quickly extracted in opposed axial direction. This known method is not suitable for producing molded parts with two or more threads side-by-side.

### SUMMARY

The object of the invention is to specify a simple and economical method of the kind initially mentioned, suitable for primary shaping of internal threads of greater axial length. Another object of the invention is to create a molded part with internal thread, easily produced by primary shaping, and suitable for greater loads.

According to the invention, the object with respect to the method is accomplished by the features of claim 1, and with respect to the molded part, by the features of claim 6. Advantageous embodiments of the method and of the part are specified in the subsidiary claims subordinate to each of these independent claims.

The method according to the invention provides that the portions of the internal thread are formed by a first molding core, comprising thread portions in first sectors for forming the internal thread, and unthreaded recesses in second sectors located between the first sectors, the first and second sectors in particular each extending over equal central angles, that second molding cores arranged in the recesses of the first molding core form unthreaded wall segments of the opening, and that to unmold the molded part, first the second molding cores are withdrawn from the opening in axial direction, then the first molding core is rotated in the molded part far enough to bring its threaded portions in opposition to the unthreaded segments of the opening, and then withdraw them from the opening in axial direction.

In the method according to the invention, the unmolding, besides the axial motion of the two cores and regardless of the axial length of the internal thread, only a rotation of the first molding core by an angle of 360° divided by the sum of the first and second sectors is required. This makes possible a simple and rapid unmolding of the molded parts and leads to a considerably simpler and more compact conformation of the mold tools. The rotation of the first molding core requires no costly drives but can be effected by means of a simple cam control, transforming an axial motion into a rotation through the required angle. Overall, therefore, the method according to the invention makes possible an especially economical production of molded parts with internal thread.

In the molded parts produced according to the invention, the internal thread does extend over only a portion of the internal surface of the opening. For many applications, however, this is sufficient, and higher holding forces can be achieved with molded parts having a smooth opening, into the wall of which the threads of the bolt will dig when screwed in. The unthreaded wall segments of the opening may be configured as lengthwise grooves that form stripping or cutting edges at the ends of the portions of internal threads, serving to remove remnants of varnish, subsoil protection or the like, from bolts screwed into the opening, while the grooves accommodate the material removed.

The second molding cores, in the method according to the invention, offer the possibility of assigning a shape suitable for performing additional functions in the unthreaded sectors. The radial mean distance of the core surface forming the unthreaded wall segments of the second cores may here be equal to or greater than the outside radius of the internal thread. The second molding cores may be of any cross-sectional shape, for example a circular, oval or polygonal cross-section. Preferably, the second mold cores are configured as cylindrical pins, the first mold core having partial cylindrical grooves in the second sectors, in which the cylindrical pins are guided.

The number of second molding cores may vary. It is determined by the number of sectors, and may be two or more. Especially advantageous is an embodiment having six sectors, whose central angle is 60° and comprises the three second molding cores. This results in a sufficiently uniform distribution of the portions of internal thread over the periphery, with sufficient length of the individual portions.

The molded part produced by primary shaping using the method according to this invention has an opening having at least two portions of a thread, arranged in various first sectors of the opening, second sectors with unthreaded wall segments being arranged between the first sectors, located radially outside of the rotational contours of the internal thread. Preferably, the first and second sectors each have equal central angles of at most 90°. The molded part fashioned according to the invention may in particular be simply and inexpensively produced from synthetic materials. The internal threaded of the molded part, without disadvantageous influence of the process of manufacture, may have a comparatively great axial length, and the unthreaded wall segments may be used to realize additional functional features. For example, the unthreaded wall segments may be configured as axially parallel, in particular part cylindrical grooves, forming stripping or cutting edges at their margins, stripping off material adhering to the surface of a bolt or screw, such as paint, subsoil protection, wax or dirt, said grooves accommodating the material stripped off, so that the screwing operation is not interfered with by this material and any damage to the internal thread is avoided.

The molded part according to the invention may advantageously form a nut having a tool hold coaxially with the internal thread on its outer periphery, in particular a hexagon.

In the case of a hexagonal tool grip, it is advantageous if three first sectors in the opening are provided with threaded portions and two second wall segments left unthreaded, the central angles of the sectors being 60°. Further, it is expedient if the unthreaded wall segments are each neighboring to vertices of the tool holds, since this results in a better utilization of material.

### DRAWINGS

The invention will now be illustrated in more detail in terms of embodiments by way of example, as represented in the drawings. In the drawings.

FIG. 1 shows a cross-section of a molding tool for unmolding a molded part by the method of the invention during the molding operation;

FIG. 2 shows a cross-section of the molding tool of FIG. 1 in a position provided for final molding;

FIG. 3 shows an axial section of a molded part primary shaped by the molding tool according to FIG. 1; and

FIG. 4 shows a view of the molded part according to FIG. 3 in axial direction.

### DETAILED DESCRIPTION

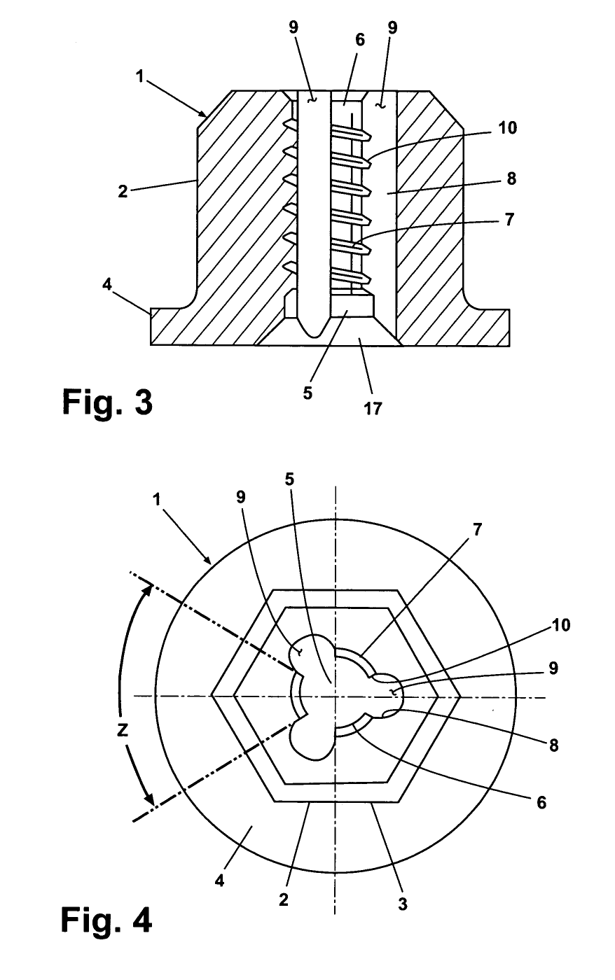

The molded part 1 represented in FIGS. 3 and 4 is a nut consisting of a thermoplastic synthetic material and primary shaped by the injection molding process. The molded part 1 has an outside contour in the form of a hexagonal prism. This outside contour forms a tool hold 2 with wrench surfaces 3. On one front, the molded part 1 comprises a molded-on circular disk shaped flange 4.

In lengthwise direction of the hexagonal prism, a central through opening 5 extends through the molded part 1 to accommodate a bolt or screw provided with an external thread. The opening 5 is articulated in six sectors, alternately of different conformation and all having essentially the same central angle Z, equal to 60°. In three sectors, the opening is bounded by segments 6 of a cylindrical bore surface, in which portions 7 of an undercut internal thread are configured. In the intervening sectors, the opening 5 comprises unthreaded wall areas 8 having a concave curvature and forming a partial cylindrical groove 9 in each sector. The grooves 9 are axially parallel and have a constant cross-section. The shape and location of the grooves 9 form sharp stripping or cutting edges 10 at the ends of the portion 7 of the internal thread, stripping off material adhering thereto when a threaded bolt is screwed in and thus preventing any hindrance or destruction of the thread of the molded part 1. The material stripped off can collect in the clear spaces created by the groove 9 and also escape at the open ends of the groove 9.

On the flange side, the opening comprises an entrance portion 17 enlarging conically to the outside, which facilitates the attachment and screwing of the molded part onto a threaded bolt. The opposed end of the opening 5 is open, but may alternatively be made closed.

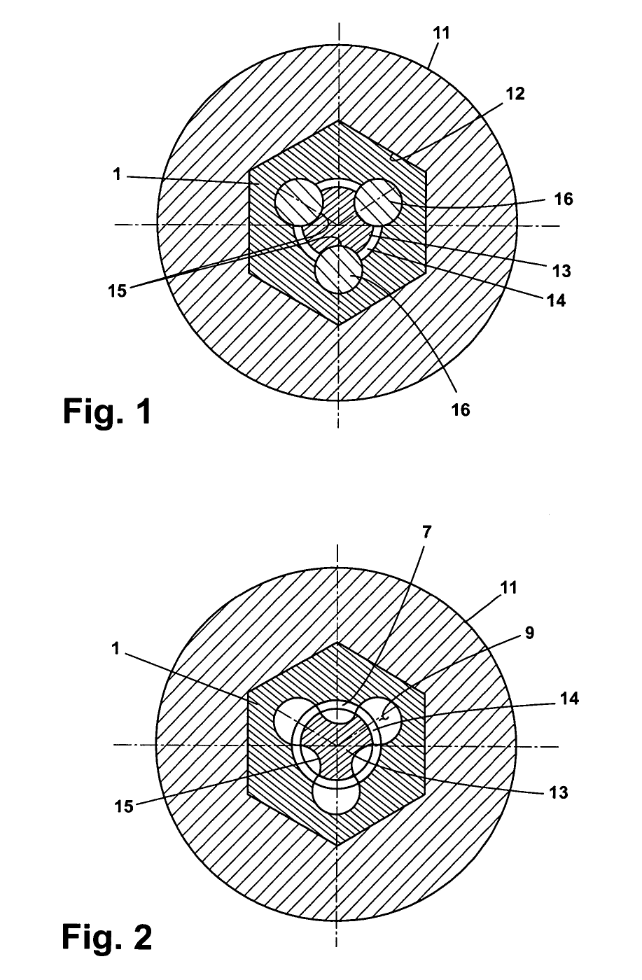

With reference to FIGS. 1 and 2, the method of primary shaping of the molded parts 1 is illustrated in the following. What is shown is the cross-section of an injection casting mold 11 enclosing a cavity 12 in the shape of the outer contour of the molded part 1. In the drawing, all there is to be seen is the hexagonal cross-section of the cavity 12 in the neighborhood of the tool hold 2 of the molded part 1. In the center of the cavity 12 there is a first molding core 13, having threaded portions 14 in three sectors to form the portions 7 of the internal thread of the molded part 1. In the sectors lying between the threaded portions 14, the first molding core 13 has partial cylindrical grooves 15 in which two cores 16 are arranged. The second molding core 16 has the form of cylindrical pins whose peripheries have the same curvature as the wall surfaces of the groove 15. Thus the second molding core 16 lies freely without sway in contact with the wall surfaces of the grooves 15. They may also be movable in lengthwise direction of the grooves 15.

Expediently, the second cores 16 are connected to each other outside of the cavity 12 of the injection casting mold 11, so that they travel jointly relative to the first molding core 13 and can be drawn out of the molded part 1 for unmolding. The first molding core 13 is likewise axially movable and moreover rotatable to a limited extent on its longitudinal axis.

FIG. 1 shows the cores 13, 16, in the position intended for injection casting of the molding part 1. When the injection casting process is terminated, for unmolding first the second cores 16 are drawn out of the opening 5 of the molded parts. The grooves 9 formed by the second cores 16 are now empty and form clear spaces into which the threaded portions 14 can be moved by rotating the first molding core 13. FIG. 2 shows the first unmolding condition, in which, after a rotation of the core 13 through the central angle Z of the sectors of the threaded portions 14 are located completely within the grooves 9. In this position, the threaded portions 14 are no longer in engagement with the threaded portion of the molded part 1, so that the first molding core 13 can also be pulled out of the molded part 1 in axial direction. Then the molded part 1 can be ejected from the previously already opened injection casting mold 11 with the aid of an ejector.

As the procedure described shows, unmolding of the first core 13 requires only a brief rotation thereof. This can be accomplished with a simple drive, inexpensive to construct and requiring little space. The time-consuming screwing out of a conventional core is eliminated.

What is claimed is:

1. A molded part, comprising:
a body including a tool hold outer surface;
an opening having an internal thread;
at least two portions of the thread arranged in different first sectors of the opening; and
at least two second sectors each having an unthreaded wall surface, each of the second sectors alternately positioned between the first sectors containing the portions of the internal thread, the unthreaded wall surface located radially outside a rotational contour of the internal thread.

2. The molded part according to claim 1, wherein the first and second sectors comprise equal central angles.

3. The molded part according to claim 2, wherein the unthreaded wall surfaces comprise axially parallel partial cylindrical grooves.

4. The molded part according to claim 1, wherein the molded part comprises a nut having a tool hold on an outer periphery coaxial with the internal thread.

5. The molded part according to claim 4, wherein the unthreaded wall segments are each positionable proximate to vertices of the tool hold.

6. The molded part according to claim 1, wherein the grooves each comprise a cutting edge at a margin of the grooves.

7. The molded part according to claim 1, comprising each of three first and three second sectors each having a central angle of 60°.

8. The molded part according to claim 1, comprising:
an introductory portion configured at an entrance end of the opening having an outwardly enlarged cross section adapted to receive a threaded fastener; and
a flange radially extending from the body proximate the introductory portion.

9. The molded part according to claim 1, comprising a cutting edge between each groove and a proximate one of the threaded portions.

10. A method for shaping a molded part having an opening and an internal thread created in sectors in the opening, the method comprising:
adapting a mold to receive a first molding core and a plurality of second molding cores;
creating multiple threaded portions spaced in a plurality of first sectors in the first molding core, each threaded portion defining one of the sectors of the internal thread;
forming grooves defining a plurality of second sectors of the first molding core each positioned between proximate ones of the first sectors;
positioning each of the second molding cores in one of the grooves operable to form unthreaded wall segments of the opening;
filling the mold with a polymeric material to create the molded part; and
performing steps in the following order to remove the molded part from the mold:
drawing out the second molding cores in an axial direction; and
repositioning the first molding core for removal from the opening in the axial direction.

11. The method of claim 10, further comprising configuring the first and second sectors with substantially equal central angles.

12. The method of claim 11, further comprising limiting the central angle of each of the first and second sectors to a maximum of 90°.

13. The method of claim 11, further comprising creating the central angle of each of the first and second sectors at an angle of 60°.

14. The method according to claim 10, further comprising positioning the unthreaded wall segments such that a radial mean distance to the unthreaded wall segments is at least equal to an outside radius of the internal thread.

15. The method of claim 10, further comprising configuring the second molding cores as cylindrical pins, each having a curvature substantially equal to a surface curvature of individual ones of the grooves of the first molding core.

16. The method of claim 10, further comprising centrally positioning the first molding core in the mold prior to the positioning step.

17. The method of claim 10, further comprising connecting each of the second molding cores together for jointly sliding into and out of the grooves.

18. The method of claim 10, further comprising rotating the first molding core in the molded part until the threaded portions each face one of the unthreaded wall segments of the opening during the repositioning step.

19. A method for shaping a molded part having an opening and an internal thread created in sectors in the opening, the method comprising:
adapting a mold having a first cavity for creating a molded part having a tool hold and to centrally receive a first molding core and a plurality of second molding cores;
shaping the first molding core by the steps of:
creating multiple threaded portions spaced in a plurality of first sectors, each threaded portion defining one of the sectors of the internal thread; and
forming axially longitudinal grooves defining a plurality of second sectors each positioned between proximate ones of the first sectors;
positioning each of the second molding cores in one of the grooves operable to form unthreaded wall segments of the opening;
filling the mold with a polymeric material to create the molded part; and
performing steps in the following order to remove the molded part from the mold:
drawing out the second molding cores in an axial direction;
rotating the first molding core in the molded part until the threaded portions each face one of the unthreaded wall segments of the opening; and
withdrawing the first molding core from the opening in the axial direction.

20. The method of claim 19, further comprising configuring the first and second sectors with substantially equal central angles.

21. The method of claim 19, further comprising limiting a rotation of the first molding core during the rotating step to a value of the central angle.

22. The method of claim 19, further comprising configuring the first cavity in a hexagonal shape.

23. The method of claim 19, further comprising ejecting the molded part from the mold after the withdrawing step.

24. The method of claim 19, further comprising:
creating the longitudinal grooves as partially cylindrical grooves, defining a cutting edge between each longitudinal groove and a proximate one of the threaded portions; and
shaping each of the second molding cores as a cylindrical tube substantially matching a geometry of the partially cylindrical grooves.

25. The method of claim 19, further comprising:
creating the longitudinal grooves as partially oval grooves; and
shaping each of the second molding cores as an oval tube substantially matching a geometry of the partially oval grooves.

26. The method of claim 19, further comprising:
creating the longitudinal grooves as partially polygonal grooves; and
shaping each of the second molding cores as a polygonal tube substantially matching a geometry of the partially polygonal grooves.
